(19) United States
(12) Patent Application Publication
(10) Pub. No.: US 2007/0064111 A1
(43) Pub. Date: Mar. 22, 2007

(54) Digital camera and image information transmission method

(75) Inventors: Tatsuhiko Ikehata, Ome-shi (JP); Tatsuro Abe, Ome-shi (JP); Kei Tashiro, Ome-shi (JP); Toyokazu Aizawa, Sagamihara-shi (JP); Shiro Nagaoka, Ome-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/517,451

(22) Filed: Sep. 8, 2006

(30) Foreign Application Priority Data
Sep. 16, 2005 (JP) 2005-271086

(51) Int. Cl. H04N 5/225

(52) U.S. Cl. 348/207.2

(57) ABSTRACT

At least one image file containing an image to be printed is selected from the image files recorded in a recording medium, for example, HDD by a user. Then a camera and a printer are connected. Responsive to a file information transmission request that requests the transmission of all image files recorded in a media, a digital camera transmits only the file information and the file ID of each of the image files selected by the user to the printer. After authentication, the digital camera transmits the file. ID of each of all the selected image files responsive to a file ID transmission request that requests the transmission of image files to be printed, from the printer.

### CROSS-REFERENCE TO RELATED APPLICATIONS

This application is based upon and claims the benefit of priority from Japanese Patent Application No. 2005-271086, filed Sep. 16, 2005, the entire contents of which are incorporated herein by reference.

### BACKGROUND

1. Field

The present invention relates to a digital camera which compresses image data obtained by photographing, records it as an image file in a recording medium, and prints an image of the image file recorded using a PictBridge compliant printer.

2. Description of the Related Art

A common method of printing an image photographed by a digital camera is that the image file is transferred from the camera to a personal computer, and the personal computer decompresses the transferred image file and transmits the resultant data to a printer. Recently, a system has been developed in which an image file is directly transmitted to a printer from a digital camera, and the printer prints the image.

Jpn. Pat. Appln. KOKAI Publication No. 2005-88572 discloses a system in which even when a camera and a printer, which are manufactured by different manufacturers, are directly connected to each other, the camera easily designates a recording mode in the printer, and the printer is able to print according to its recording functions.

A standard, called PictBridge, has been established which defines rules on a system in which a digital camera and a printer are directly connected as described above and images recorded in the digital camera are directly printed through operations from the digital camera. The PictBridge is a communication standard applied when image data is transferred to the printer according to PTP (picture transfer protocol) and is printed.

Description is given about a general sequence of operations performed when an image recorded in a digital camera is printed by a printer according to the PictBridge standard. To start with, the digital camera is connected to the printer by, for example, a USB cable. In turn, the digital camera allots file IDs to all the image files recorded in a recording medium, and transfers file information on all the image files, together with the file IDs, to the printer. At this time, the image files (image data) per se are not transferred. The file IDs allotted to the file information are subsequently used for managing the transfer of image files to and from the printer.

When the file information transfer ends, to check that the devices are PictBridge compliant, authentication is made by verifying if a specific file is present, and the connection of PictBridge is established. Subsequently, a user selects an image he wants to print on the digital camera and instructs to start printing. Responsive to this, the digital camera sends a file ID of the selected image file to the printer, and the printer starts actual printing operation.

Recently, a capacity of the recording medium used for digital cameras has been increased, and a single recording medium is capable of recording several thousands of images. For example of the recording medium, an SD memory card has a capacity of about 2 Gbytes, and an HDD has a capacity of about 20 Gbytes. The digital camera containing an HDD having such a large capacity is capable of storing several tens of thousands of images.

Thus, in the conventional PictBridge connection sequence, to print the image, even if its number is only one image, all the file information of several thousands to several tens of thousands of images stored in the recording medium must be sent to the printer. Accordingly, much time must be taken only for the transmission of the file information. In a specific example of a digital camera and a printer, about 30 seconds are sometimes taken for the transfer of the file information of 1,000 images. Accordingly, to transmit several thousands to several tens thousands images, from several minutes to several tens of minutes may be taken till the PictBridge authentication ends.

If a large number of images, exceeding the number of files that the printer can manage, are present within the camera, the printer fails to manage the files and will suffer from overflow.

### BRIEF DESCRIPTION OF THE SEVERAL VIEWS OF THE DRAWINGS

A general architecture that implements the various feature of the invention will be described with reference to the drawings. The drawings and the associated descriptions are provided to illustrate embodiments of the invention and not to limit the scope of the invention.

FIG. 1 is a block diagram showing a configuration including optical and electrical systems in a digital camera to which the present invention is applied;

FIG. 2 is a flow chart showing a printing process, which is compatible with the PictBridge print standard, according to an embodiment of the invention;

FIG. 3 is a diagram exemplarily showing an image select screen; and

FIG. 4 is a diagram exemplarily showing a print setting screen.

### DETAILED DESCRIPTION

Various embodiments according to the invention will now be described hereinafter with reference to the accompanying drawings. In general, according to one embodiment of the invention, to print using a PictBridge compliant printer, first, images to be printed are selected, then a camera and the printer is connected, and information concerning only the selected images is transferred to the printer, thereby image information transfer time can be reduced.

In the case of printing in ordinary homes, the number of images printed one time is at most several to several tens. Accordingly, even when a large number of images are stored in a recording medium of a camera, an embodiment of the present invention enables the user to start printing operations within the shortest possible waiting time. The invention realizes the speed-up of the image information transfer from a digital camera using PictBridge.

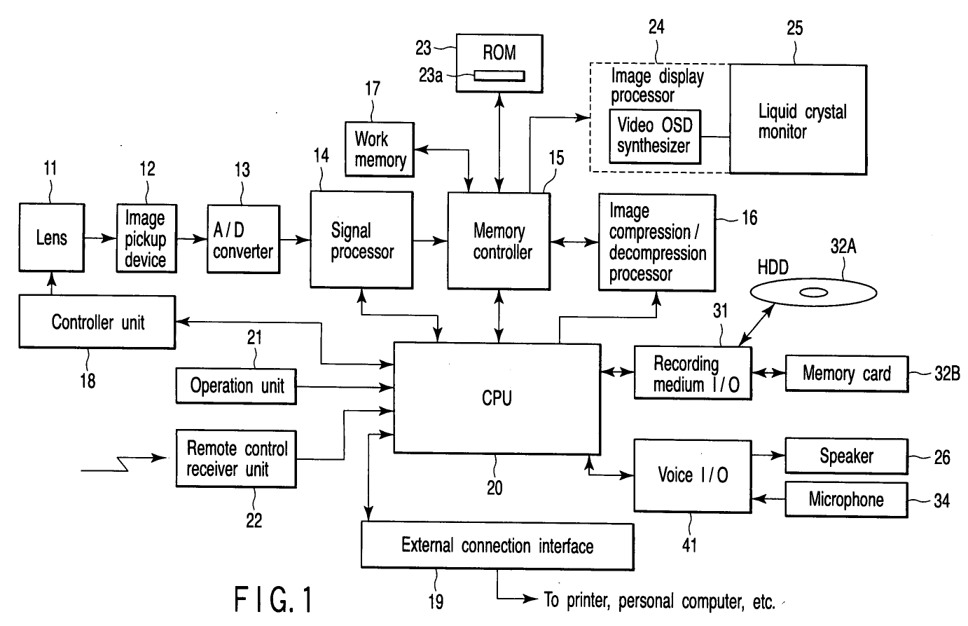

FIG. 1 is a block diagram showing a configuration including optical and electrical systems in a digital camera 1 to which the present invention is applied. An object image, which comes in through a lens 101, is imaged on an imaging face of an image pickup device 12 (e.g., CCD image pickup device). The object image is converted into an electrical signal; the electrical signal is converted into a digital signal by an analog to digital (A/D) converter 13; and the digital signal is input to a signal processor 14. In the signal processor 14, the digital signal is subjected to various signal processing of gamma correction, color signal separation, and white balance adjustment, and the like. The image pickup device 12, the A/D converter 13, the signal processor 14 and the like serve as an image pickup unit.

When a shutter operation is not carried out in a normal image pickup state, image data output from the signal processor 14 is input to an image display processor 24 through a memory controller 15. The processor carries out a conversion process for displaying the picked up image on a liquid crystal monitor 25, and a synthesizing process of synthesizing menu and the like. The image data output from the image display processor 24 is input to the liquid crystal monitor 25. In turn, an image being picked up or an object image at which the user points the camera is displayed on the liquid crystal monitor 25.

When the shutter is operated, the picked up image data is compressed (for example, in JPEG mode) in an image compression/decompression processor 16, and the compressed data is stored into a hard disc 32A or a memory card 32B such as an SD card through a recording medium I/O 31 under control of a CPU (central processing unit) 20. The recording medium is not limited to those media and may be an optical disc.

When the image data stored in the recording medium is read out, the image data is decompressed in the image compression/decompression processor 16, and is input to the image display processor 24 through the memory controller 15, under the control of the CPU 20. As a result, a playback image is displayed on the liquid crystal monitor 25.

Various control programs and the like to be executed by the CPU 20 are stored in a ROM 23. A work memory 17 is used, for example, when image data is edited, thumbnail images are formed or the order of images is changed. Further, it is used also for editing various types of icons. The work memory 17 is capable of storing image data of one screen or plural screens. The image data stored in the work memory 17 is input to the image display processor 24 through the memory controller 15, so that image editing conditions may be checked on the liquid crystal monitor 25.

In edit mode or image pickup mode, voice data may also be input to the digital camera via a microphone 43 or a voice I/O 41. The voice data is recorded into the recording medium, while being paired with the picked up image data. When the recorded voice data is played back, the camera can read out the voice data as well as the picked up image data from the recording medium, and output a voice from a speaker 26 through a recording medium I/O 31, while playing back the image. If necessary, the voice may not be played back when the image is played back and checked.

Operation signals are input to the CPU 20 from exterior, through an operation unit 21 and a remote control receiver unit 22. In image pickup mode, the CPU 20 responds to the operation signals to perform zooming adjustment, automatic iris adjustment (AE), automatic focusing adjustment (AF), flashing control, and the like, through a controller unit 18. The CPU 20 is also connected to an external connection interface 19, and is capable of transferring image data to and from an external device, such as a printer, a personal computer or a TV, through an USB cable, for example.

A printing process according to the present invention will now be described.

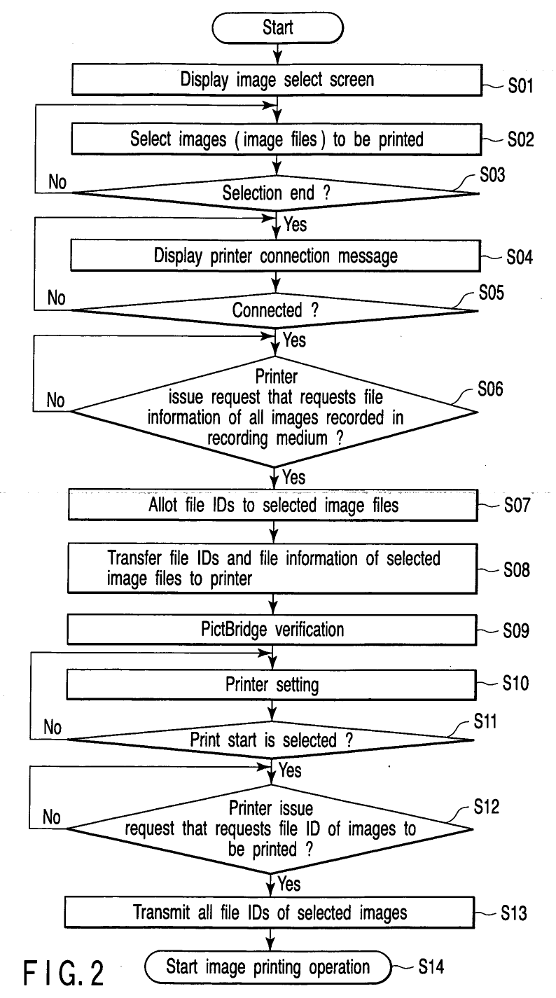

FIG. 2 is a flow chart showing a printing process, which is compatible with the PictBridge print standard, according to an embodiment of the invention. This flow chart shows a sequence from an instant that an image to be printed is selected on the camera side till the printer starts printing. The flow chart is showing a part of an application software stored as a print processor 23a in the ROM 23. The print processor 23a may also be stored in a manner that it is stored in the hard disc 32A and loaded into the work memory 17 whenever occasion calls.

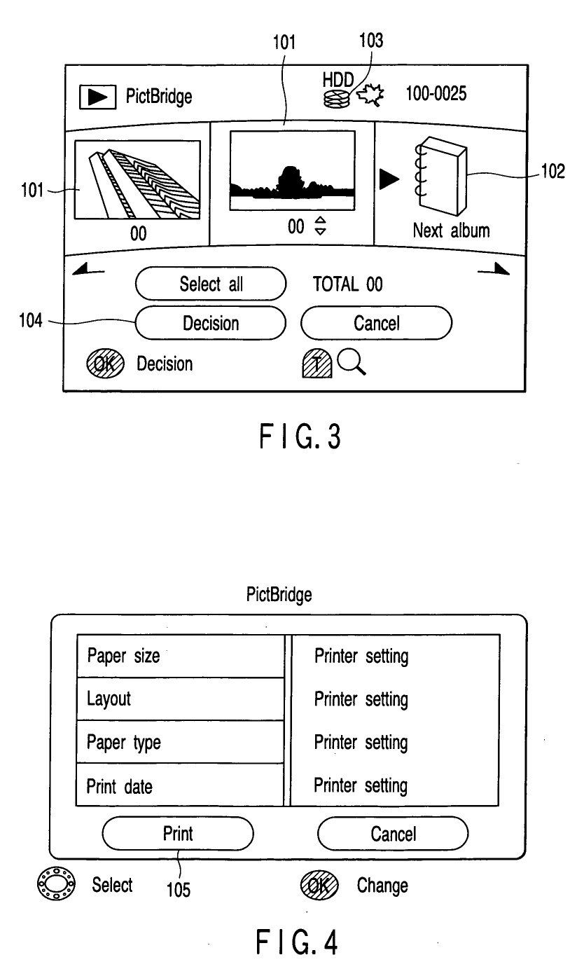

When a user selects a PictBridge print mode on the menu screen of the digital camera, the CPU 20 displays an image select screen as shown in FIG. 3 (S01). A reduced image 101 displayed on the image select screen is an image recorded in the recording medium. The reduced image 101 is horizontally scrolled and the next image or the previous image is successively displayed, by rotating a jog dial (not shown) provided on the operation unit 21. An album 102 in the figure shows a folder containing a plurality of images. By selecting the album 102, a reduced image of the image contained in the album is displayed. In this instance, an image stored in the HDD, like an icon 103, is displayed. Switching from the hard disc 32A to the memory card 32B or vice versa is also possible.

A reduced image displayed at the central part of the image select screen is an image currently selected. When an OK button (not shown) in the operation unit 21 is depressed, the selection of the image (image file) is determined (S02). In this way, a plurality of images to be printed may be selected from the images recorded in the hard disc 32A and/or the memory card 32B.

The user selects and operates a “decision” 104. Responsive to this, the CPU 20 detects the end of the image selection (S03), and displays a message to instruct user to connect the digital camera to the printer by a USB cable (S04). When detecting the connection of the digital camera and the printer (Yes in S05), the CPU 20 decides if a transmission request, issued from the printer, for requesting transmission of the file information on all the images recorded in the recording medium of the camera is present (S06). If the transmission request is present (Yes in S06), the CPU 20 extracts only the image files that are selected by the user in step S02, not the file information on all the images stored in the recording medium (HDD in this instance), and allots file IDs (e.g., serial numbers) to those image files (S07). The CPU 20 transfers the file IDs and the file information of the selected image files to the printer (S08).

The file information contains for example, an identifier indicating that the image is picked up by the digital camera, a folder name of a folder (album) containing the image file, a file name of each of the images, recording date, and the like. Subsequently, the image file is specified by the file ID, and the transfer of the image file to and from the printer is managed using the file ID. At a time point where the file ID and the file information of the selected image has been transferred to the printer, the printer decides that the file ID and the file information of the image recorded in the camera have all been transferred.

When the transfer of the file information ends, the camera and the printer mutually authenticate that those devices are PictBridge compliant devices. That is, the camera and the printer mutually authenticate by checking if a specific file is present (S09), and PictBridge connection is set up. After the authentication, the CPU 20 receives information indicating a current status of the printer (paper sizes of papers contained and the like) from the printer, and displays a print setting screen as shown in FIG. 4. Print sheet size and a layout of the images, if a plurality of images are printed on a single print sheet and the like are set according to a select input by the user on the print setting screen (S10).

When “print” 105 is selected on the print setting screen (Yes on S11), the CPU 20 decides if a request that requests the transmission of file IDs of images to be printed, issued form the printer is present (S12). If the transmission request is present (Yes on S12), the CPU 20 sends the file IDs of the images to be printed, that is, all the file IDs allotted to the image files selected in the step S07, to the printer (S13).

Subsequently, in response to a data transmission request that requests the camera to send data attendant with the file ID from the printer, the CPU 20 sends an image file (compressed image data) corresponding to the file ID to the printer, and the printer starts printing (S14). In case where a plurality of images are to be printed, the printer sends a data transmission request that requests the camera to send data attendant with the next file ID every time it ends reception of one image file. Responding to each of the requests, the CPU 20 sends the corresponding image file to the printer.

As described above, in the embodiment of the present invention, after an image to be printed is selected as in the step S02, the digital camera and the printer are connected as in the steps S04 and S05, the file ID and the file information of the selected image are sent to the printer. While in the prior art, the digital camera and the printer are first connected, the camera sends the file IDs and the file information of all the image files recorded in the recording medium to the printer regardless of necessity of printing. Accordingly, several tens minutes are sometimes taken only for sending the file IDs and the file information of all the image files. On the other hand, in the present invention, the file ID and the file information only of the image file selected for printing are sent to the printer as the step S08. Accordingly, the time taken for the data transmission is remarkably reduced.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A digital camera which carries out image printing using a PictBridge compliant printer, comprising:
an image pickup unit which picks up an optical image and provides image data corresponding the optical image;
a recording unit having a recording medium, the recording unit compressing image data obtained by the image pickup unit and recording the compressed data as an image file to the recording medium;
a selector unit for selecting at least one image file containing an image to be printed from the image files recorded in the recording medium;
a verifying unit which verifies the connection of the digital camera to the printer;
an allotting unit which allots a file ID to each of the image files selected by the selector unit responsive to a first transmission request from the printer when the connection with the printer is verified, and which transmits the file information and the file ID of the selected image file to the printer;
a file ID transmitting unit which transmits all the file IDs allotted to the image files selected by the selector unit to the printer responsive to a second transmission request from the printer; and
an image file transmitting unit which transmits image files corresponding to the transmitted file IDs responsive to a third transmission request from the printer.

2. The digital camera according to claim 1, further comprising an authentication unit which mutually authenticates the digital camera and the printer with each other as to if they are PictBridge compliant devices,
the file ID transmitting unit transmitting all the file IDs allotted to the image files to the printer when the authentication unit authenticates that the printer is a PictBridge compliant device.

3. A digital camera according to claim 1, wherein the recording medium is an HDD.

4. An image information transmitting method to be applied to a digital camera which carries out image printing using a PictBridge compliant printer, the method comprising:
selecting at least one image file containing an image to be printed from the image files recorded in a recording medium;
verifying the connection of the digital camera to the printer;
allotting a file ID to each of the image files selected by the selecting operation responsive to a first transmission request from the printer, and transmitting the file information and the file IDs of the selected image files to the printer when the connection of the printer is verified;
transmitting all the file IDs allotted to the image files selected by the selecting operation to the printer responsive to a second transmission request from the printer; and
transmitting image files corresponding to the transmitted file IDs responsive to a third transmission request from the printer.

5. An image information transmitting method according to claim 4, further comprising mutually authenticating the digital camera and the printer with each other as to if they are PictBridge compliant devices, and wherein the transmitting all the file IDs includes transmitting all the file IDs allotted to the image files to the printer when the printer is authenticated by the authenticating.
